(19) United States
(12) Patent Application Publication
(10) Pub. No.: US 2010/0097235 A1
(43) Pub. Date: Apr. 22, 2010

(54) Explosion Proof Non-Contact Check Point to Mount in Explosion Proof Enclosure

(75) Inventor: David C. Holloway, Baldwinsville, NY (US)

Correspondence Address: KING & SPALDING, LLP, 1100 LOUISIANA ST., STE. 4000, ATTN.: IP Docketing, HOUSTON, TX, 77002-5213, US

(73) Assignee: COOPER TECHNOLOGIES COMPANY, Houston, TX (US)

(21) Appl. No.: 12/256,109

(22) Filed: Oct. 22, 2008

(51) Int. Cl. G08B 21/00

(52) U.S. Cl. 340/660

(57) ABSTRACT

A voltage indicating device comprises a test port disposed in a casing that allows the test port to operate during extreme conditions, such as corrosive or explosive environments. The indicating device is coupled to a housing enclosing an electrical apparatus and is connected to a power source of the electrical apparatus. The test port is accessible outside the housing and allows a user to determine voltage or current presence prior to opening the housing, thus preventing electrocution.

### TECHNICAL FIELD

The present application generally relates to electrical indicators. More particularly, the present application relates to electrical indicators capable of operating in and withstanding hazardous conditions.

### BACKGROUND

High voltage equipment may pose a danger to a user if the user attempts to access the interior of the high voltage equipment while it is still receiving power. Typically, the high voltage equipment includes an electrical indicator for alerting the user that current is being supplied to a piece of electrical equipment. However, these indicators typically are not rugged and may be easily damaged in certain environments (for example, corrosive, explosive, dusty, humid, wet, or other such environments). As a result, the indicators may become unreliable and provide incorrect information to the user, which may lead to an unsafe condition. For example, conventional indicators may become damaged and indicate that current is not being supplied to a piece of high voltage equipment, when in fact a very high voltage may be present in the equipment.

Therefore, a need exists for an electrical indicating device capable of allowing users to determine if an electrical apparatus is receiving power from a power source even after the apparatus has experienced adverse conditions that might render a conventional indicator unreliable.

### SUMMARY

The present application relates generally to inspection of an enclosure housing an electrical apparatus. More particularly, the present application relates to an indicating device for determining voltage presence within the enclosure and capable of operating during extreme conditions that might render conventional indicators non-functional. The indicating device is accessible outside the housing and allows users to determine if the electrical apparatus is receiving power before opening the housing, thus preventing electrocution or arc flash hazard.

The indicating devices of the present invention include an electrical status test port housed in a protective casing. The casing comprises a material that protects the test port from harmful external conditions, such as mechanical abuse or corrosives. The casing may also protect the test port from impacts, vapors, water, dust, dirt, or other harmful factors. The casing may be non-conductive or partially non-conductive. The casing may have a threaded outer surface for mating with a correspondingly threaded opening of a housing enclosing an electrical apparatus. In an alternative embodiment, the casing may be integrally formed with the housing enclosing an electrical apparatus. In some aspects of the invention, the casing includes a lip extending orthogonally from an end thereof. The lip and a portion of the test port may be visible to the user on an exterior of the housing. In some aspects of the invention, the test port may be covered with a ceramic diaphragm. The test port may have openings, or terminals, that give access to the user to safely determine if a voltage is present in the electrical apparatus.

Systems of the present invention include the indicating device coupled to a housing enclosing one or more electrical devices. The indicating device is coupled to a power source and an indicating tool may be used by the user to determine if voltage or current is present within the housing. The use of the indicating device may be used as a sole indicator of the status of the electrical device, or may be a redundant indicator to be used in combination with several other indicators. The indicating tool may be a probe, a multi-purpose tool designed to interface with the test port, a visual indicator such as an LED, an audible alarm, a wireless transmitter, a PDA, or any combination thereof.

These and other aspects, objects, features, and embodiments of the present invention will become apparent to those having ordinary skill in the art upon consideration of the following detailed description of illustrative embodiments exemplifying the best mode for carrying out the invention as presently perceived.

### BRIEF DESCRIPTION OF THE DRAWINGS

The present invention may be better understood by reading the following description of non-limiting embodiments with reference to the attached drawings wherein like parts of each of the several figures are identified by the same reference character, and which are briefly described as follows.

FIG. 1A is a perspective view of an indicating device according to an exemplary embodiment.

FIG. 1B is a side cross-sectional view of the indicating device of FIG. 1A according to an exemplary embodiment.

FIG. 1C is a front view of the indicating device of FIG. 1A according to an exemplary embodiment.

FIG. 2 is a perspective view of the indicating device of FIG. 1A in contact with an interface tool according to an exemplary embodiment.

FIG. 3 is a side cross sectional view of the indicating device of FIG. 1A inserted into an outer panel of an electrical apparatus according to an exemplary embodiment.

### DETAILED DESCRIPTION OF EXEMPLARY EMBODIMENTS

The invention provides an indicating device that can allow users to determine if an electrical apparatus is receiving power prior to opening an enclosure of or a housing of the electrical apparatus, thereby preventing possible electrocution or arc flash. Generally, the indicating devices of the present invention are capable of operating under extreme conditions or without maintenance that could render conventional indicators unreliable or non-functional.

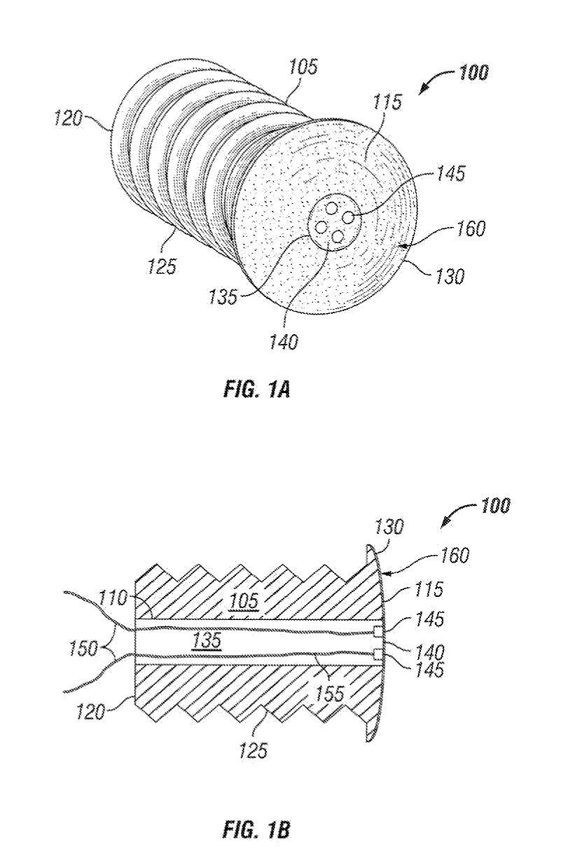

FIGS. 1A-1C illustrate several views of an electrical indicating device 100 according to an exemplary embodiment. The indicating device 100 comprises a casing 105. The casing 105 comprises a cylindrical opening 110 traversing the length of the casing 105 from a front interface end 115 to a rear connection end 120. In some exemplary embodiments, the exterior of the casing 105 may have a threaded surface 125. In certain exemplary embodiments, the casing 105 comprises a lip 130 that extends outwardly from the casing 105 at the interface end 115. In certain exemplary embodiments, the casing 105 comprises a lip 130 that extends outwardly from the casing 105 at the rear connection end 120 or both the rear connection end 120 and the interface end 115. As illustrated in FIG. 1B, at least a portion of the lip 130 may extend from the casing 105 in a direction that is perpendicular to the centerline axis of the casing 105. In an exemplary embodiment, the lip 130 may be integrally formed with the casing 105.

The casing 105 may be fabricated from any suitable material. In exemplary embodiments, the casing 105 may be fabricated from a material having sufficient properties to allow the indicating device 100 to operate in adverse conditions. Suitable materials for fabricating the casing 105 include, but are not limited to, materials that are resistant to damage from an explosion, materials capable of withstanding corrosive environments, and materials generally protected from vapor damage, water damage, rust, dust, dirt, impacts, or other adverse conditions, or any combination of potentially damaging factors. In certain embodiments, the casing 105 may be fabricated from a non-conductive material. The interface end 115 and the lip 130 also may be fabricated from a non-conductive material so to prevent shock to the user. Suitable examples of non-conductive materials include, but are not limited to, polycarbonates. In some embodiments, the interface end 115 may be covered with a coating 160 to provide a non-conductive, corrosion resistant, surface. In an exemplary embodiment, the coating 160 may be a ceramic diaphragm that covers the interface end 115. In alternative embodiment, the coating 160 may cover just the exposed section of the test port 135.

The indicating device 100 also comprises a test port 135 disposed within the opening 110 of the casing 105. The test port 135 includes a front face 140 that is at least partially visible through the opening 110 in the casing 105 at the interface end 115. The front face 140 comprises a plurality of terminals 145 covered by the coating 160. At the rear connection end 120 of the casing 105, the test port 135 includes external conductors 150 which are connected to a power supply (not shown). The external conductors 150 are connected to internal conductors 155, which couple the external conductors 150 to the terminals 145.

Positioning the test port 135 within the casing 105 shields the test port 135 from the external environment while safely providing a mechanism for determining if an electrical voltage is present. As the casing 105 encasing the test port 135 is designed to prevent damage from external contaminants or to enable the test port 135 to survive an explosion, the indicating device 100 is particularly useful in applications were a potential for explosion exists or with equipment operating in an adverse environment. Additionally, at least the front face of the test port can be formed from one or more of the materials that are suitable for application in an adverse environment, as described previously with reference to the casing 105, to further protect the test port.

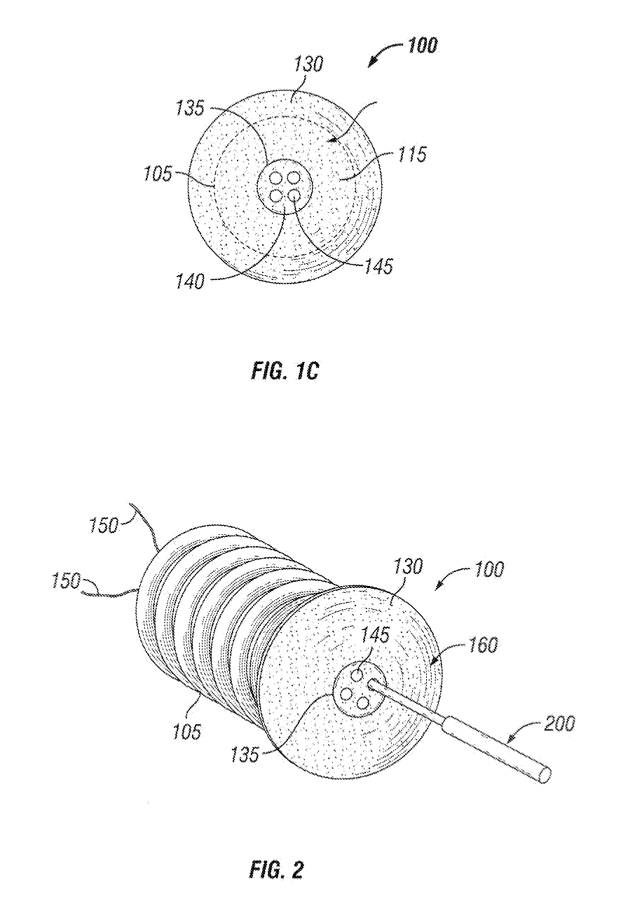

FIG. 2 is a perspective view of the indicating device 100 in contact with an interface tool 200 according to an exemplary embodiment. A user may determine if a voltage and/or current is available from the power supply by contacting the interface tool 200 to one or more of the terminals 145 of the test port 135. In an exemplary embodiment, the terminals 145 are covered by the protective coating 160 that is thin enough for the interface tool 200 to operate through. In an alternative embodiment, the terminals 145 may be exposed to the external environment. In an alternative embodiment, the terminals 145 may be exposed to the external environment, but covered by a separate, removable cover. The terminals 145 enable the user to safely determine if a voltage is present in the electrical apparatus while at the same time shielding the test port 135 from the external environment. In exemplary embodiments, an output of the tool 200 can communicate to the user if the power source is connected or disconnected based on voltage and/or current readings available through the conductors 150, 155 and the terminals 145.

In certain exemplary embodiments, the interface tool 200 may be a probe from electrical testing equipment. Suitable examples of the interface tool 200 include, but are not limited to, commercially available multimeters. In an alternative embodiment, the interface tool 200 may be able to receive information by being in proximity to the test port 135. In exemplary embodiments, the interface tool 200 may be able to receive information via electrostatic induction, or an inductive connection, when the interface tool 200 comes within proximity to the test port 135.

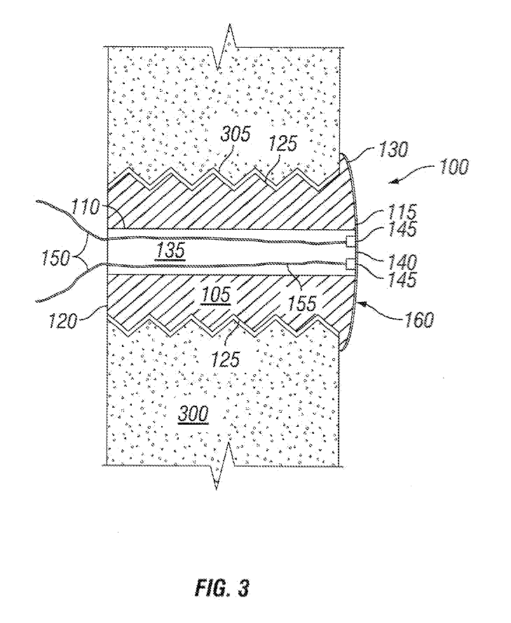

FIG. 3 is a side cross sectional view of the indicating device 100 coupled to a housing 300 for an electrical apparatus (not shown). The housing 300 of the electrical apparatus may comprise a threaded opening 305 for mating with the threaded surface 125 of the indicating device 100. Mating the threaded surface 125 with the threaded opening 305 can provide a flame path and thereby can increase the survivability of the indicating device 100 to an explosion and other hazardous conditions. In an exemplary embodiment, the housing 300 may be an explosion proof housing or a corrosion resistant or corrosion proof housing.

In some exemplary embodiments, at least a portion of the interface end 115 of the indicating device 100 extends beyond the housing 300. In certain exemplary embodiments, the lip 130 of the indicating device 100 extends beyond the diameter of the casing 105 and may create a seal between the interface end 115 and the housing 300 of the electrical apparatus. The lip 130 may thereby aid in maintaining the integrity of the electrical apparatus by covering the threaded opening 305 in the electrical apparatus. This preservation of overall system integrity may be useful in the event a damaging condition occurs, whereby the status of a power supply that may have survived the event may be determined before the user makes contact with a live circuit.

Therefore, the present invention is well adapted to attain the ends and advantages mentioned as well as those that are inherent therein. The particular embodiments disclosed above are exemplary only, as the present invention may be modified and practiced in different but equivalent manners apparent to those having ordinary skill in the art and having the benefit of the teachings herein. For example, one having ordinary skill in the art may recognize that the casing may be any shape, so long as it accommodates the test port within. The physical composition of the casing also may vary in alternative embodiments as long as the casing aids in shielding the test port. Additionally, the casing may have a non-threaded surface and the housing of the electrical apparatus may have a correspondingly non-threaded opening for receiving the indicating device. The non-threaded casing may be fastened to the electrical apparatus housing by pressure fit, adhesive, or by other means known to those having ordinary skill in the art. Furthermore, the presence of a voltage or current, in an electrical apparatus may be determined without the use of an interface tool. For example, an indicator, such as an LED, may sit adjacent to the terminals of the test port and may provide a simple visual indication of the presence, or lack thereof, of voltage. Another alternative may come from an audible alarm connected to the terminals. Alternatively, a wireless transmitter may be connected to the test port in a manner that sends a signal under particular conditions to provide an indication of the power supply status. The wireless signal could be received by a central station or by a portable reader carried by the user used in proximity to the test port. While numerous changes may be made by those having ordinary skill in the art, such changes are encompassed within the spirit of this invention as defined by the appended claims. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. The terms in the claims have their plain, ordinary meaning unless otherwise explicitly and clearly defined herein.

What is claimed is:

1. An indicating device, comprising:
a casing comprising a bore therethrough; and
a test port positioned within the bore, the test port comprising
a front face,
a rear end,
at least one terminal disposed at the front face of the test port, and
at least one first conductor, each of the at least one first conductor being connected to a corresponding one of the at least one terminal and extending from the corresponding one of the at least one terminal to the rear end of the test port.

2. The indicating device of claim 1, wherein the casing comprises a threaded outer surface.

3. The indicating device of claim 1, wherein the casing is formed from a non-conductive material.

4. The indicating device of claim 1, wherein the casing comprises a lip, the lip comprising at least a portion that extends from an end of the casing in a direction that is orthogonally to the casing.

5. The indicating device of claim 4, wherein the lip is covered with an insulating material.

6. The indicating device of claim 1, wherein at least a portion of the casing is covered with an insulating material.

7. The indicating device of claim 1, further comprising at least one second conductor, each of the at least one second conductor being connected to a corresponding one of the at least one first conductor and being disposed at least partially externally from the casing.

8. An indicating system, comprising:
a housing comprising an opening; and
a test port disposed within the opening, the test port comprising
a front face,
a rear end,
at least one terminal disposed at the front face of the test port, and
at least one first conductor, each of the at least one first conductor being connected to a corresponding one of the at least one terminal and extending from the corresponding one of the at least one terminal to the rear end of the test port.

9. The indicating system of claim 8, wherein the housing encloses an electrical apparatus.

10. The indicating system of claim 8, wherein the at least one first conductor of the test port is coupled to a power source or a power output of the electrical apparatus.

11. The indicating system of claim 8, wherein at least a portion of the test port is visible on an exterior of the housing.

12. The indicating system of claim 11, wherein the visible portion of the test port is at least partially covered with a removable insulating material.

13. The indicating system of claim 8, wherein the first opening comprises a threaded inner surface and the casing comprises a threaded outer surface for mating connection with the threaded inner surface.

14. The indicating system of claim 8, wherein the casing comprises a non-conductive material.

15. The indicating system of claim 8, wherein the casing comprises a lip extending orthogonally therefrom.

16. The indicating system of claim 8, further comprising an indicating tool configured to indicate a voltage or current presence within the housing when in contact with at least one of the at least one terminal.

17. The indicating system of claim 16, wherein the indicating tool comprises one of a probe, a multi-purpose tool, a visual test port, or an audible alarm.

18. An indicating system, comprising:
a housing comprising a first opening, wherein the housing encloses an electrical apparatus;
an indicating device disposed within the first opening and at least partially visible on an exterior of the housing, wherein the indicating device comprises a casing comprising a second opening and a test port positioned within the second opening; and
an indicating tool configured to interface with the test port to determine a voltage or current presence within the housing.
